(19) United States
(12) Patent Application Publication
(10) Pub. No.: US 2009/0144266 A1
(43) Pub. Date: Jun. 4, 2009

(54) Search method for entries in a database

(75) Inventor: Erol Bicioglu, Santa Clara, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Eclipsys Corporation

(21) Appl. No.: 11/999,384

(22) Filed: Dec. 4, 2007

(51) Int. Cl. G06F 17/30

(52) U.S. Cl. 707/5; 707/E17.014

(57) ABSTRACT

A method is provided of searching for one or more text entries in a database. The method includes steps of receiving a search term. The search term may contain a single element (e.g., word, number or abbreviation), or a group of elements such as a combination of words, numbers and/or abbreviations. A pre-processing step is performed on the search term. The pre-processing step includes adding one or more substitutions to the search term in the event that an element of the search term has an equivalent, removing exclusion words from the search term, and removing noise characters. The pre-processing step creates a search string for use in searching of the database. A search of the database is performed for entries that match, at least in part, the search string. The search results are ordered and returned. The method can be coded as software instructions and provided or furnished as a standalone software product.

### BACKGROUND

This disclosure relates generally to the field of database searching and more particularly to methods for searching for entries in a database which match a search term or phrase. The search term or search phrase (collectively referred to herein as “search term”) may be either specified by a user or specified automatically, e.g., by a software application. The methods are applicable to databases generally. The methods have particular usefulness in searching a database of medical-related terms.

Hospitals, clinics, and other medical enterprises typically implement a computerized health care information system in order to manage, share and keep track of patient information. Such systems can include an enterprise-specific database of medical-related terminology (referred to herein occasionally as a “customer catalog”). In a hospital environment, the customer catalog is used by hospital personnel for a variety of purposes as they conduct their duties, such as for example entry of orders, prescriptions or tests for patients. In particular, if a physician wishes to prescribe a particular drug for a patient, they access the customer catalog and select a drug from the catalog, and make a note to the patient's chart that a particular drug is to be administered according to a certain schedule.

Computerized health care information systems sometimes also include another database of terminology, which is typically not site specific but rather is of general applicability. For example, a hospital may implement a health care information system application which is provided by a commercial vendor and sold to many different hospitals. This application will typically include a database of terminology (referred to herein occasionally as a “source catalog”) which includes terminology which is of a more standardized nature. For example, the application may include the known VantageRx database developed and marketed by Cerner Corporation. Among other things, the VantageRx database includes a lexicon of drug names, drug product information, disease names, and coding systems which is, in some sense, standardized.

A problem arises in health care enterprises that use two different databases of medical terminology because the terminology in the customer catalog and the source catalog may not match. For example, the customer catalog may include “Ampicillin 250 mg—Inj once” as an available drug order, but that particular order may be represented by very different terminology in the source catalog, for example, as “Penicillin 250 mg/Injectable #4.”

Database servers such as Microsoft SQL Server include features for full text searching against plain character data in a relational database. The full text searching offered by a generic database server leaves much to be desired, particularly in the medical context, for reasons which will become apparent from the following discussion.

### SUMMARY

In a first aspect, a method is disclosed for searching a database for one or more entries in the database. The method includes a step (a) of receiving a search term (word or phrase, e.g., from a user). The search term can be received in any manner, such as by the user entering free text on a computer terminal or selecting a search term from a drop-down list of available search terms. In the latter example, a customer catalog may be accessed and one of the entries in the catalog is selected as a search term to find the same or equivalent term in the source catalog (or vice versa).

The method continues with a step (b) of performing a pre-processing step on the search term. The preprocessing step including sub-steps of (1) adding one or more substitutions to the search term in the event that an element of the search term has an equivalent, (2) comparing elements of the search term with an exclusion list and removing elements from the search term which are present in the exclusion list, and (3) removing noise characters from the search term. The pre-processing step results in a search string for use in searching of the database. As an example of the sub-step (1), suppose the query specified by the user was “Ampicillin 250 mg—Inj once”. The pre-processing sub-step (1) would add the substitution “Penicillin” to the search term because penicillin is a synonym (equivalent in meaning) for ampicillin. More than one substitution may be added for a given element, such as adding “haem” and “heme” if the search term contained the element “blood.” As another example, the pre-processing sub-step (1) would add the substitution “injectable” since “injectable” is an equivalent to “inj”. As an example of sub-step (2), the term “once” may be on an exclusion list and would be excluded from the search. As an example of sub-step (3), the dash (—) in the query between mg and Inj may be considered as a noise character and be deleted. Still other pre-processing steps are possible and may be advisable in certain applications to maximize the search efficiency. Pre-processing sub-steps may also be performed more than once and/or in a different order than described herein. The pre-processing step ultimately produces a search string for use in searching of the database. In the above example, the pre-processing step produces a search string containing the following elements: “Ampicillin”, “250”, “mg”, “Inj”, “injectable”, and “Penicillin”.

The method continues with a step (c) of conducting a search of the database for entries that match, at least in part, the search string created in step (b). This search may be conducted by a database server as a full text search.

The method includes a step (d) of ordering (e.g., ranking) the search results. The ordering step may take into account one or more unique weighting steps which are used to order the results. The method further includes a step (e) of returning the search results, e.g., presenting the search results to a user or returning them to a software application which provided the initial search term.

Another aspect of the invention is that it can be embodied or packaged as a software application (search tool in the form of a set of computer instructions) which is resident on a computer-readable medium such as a hard disk memory or a portable memory such as CD-ROM. The set of instructions are designed for execution by a computer, such as a general purpose computer running a commercially available operating system. The set of instructions facilitate the searching of a database for one or more entries in the database. The particular architecture or system in which the software application is used is not particularly important. One example is a hospital's computerized medical records system and the instructions are resident on a computer in the system.

The instructions stored in the memory include instructions which perform the following tasks:

(a) providing a facility for receiving a search term (e.g., from a user or application);

(b) performing a pre-processing step, including sub-steps of (1) adding one or more substitutions to the search term in the event that an element of the search term has an equivalent, (2) comparing elements of the search term with an exclusion list and removing elements from the search term which are present in the exclusion list, and (3) removing noise characters from the search term, the pre-processing step resulting in a search string for use in searching of the database.

(c) forwarding the search string to a database server;

(d) receiving a list of search results from the database server;

(e) ordering the search results, and

(f) returning the search results.

In one embodiment, the facility for receiving a search term takes the form of a menu of available search terms. In one example, the available search terms are entries in a catalog of terms present in a second database (e.g., customer catalog, which is separate from the source database). A means is provided by which a user may select one of the available search terms, such as a “search” or “OK” icon which is activated once the user has highlighted the search term they wish to invoke. The facility for receiving a search term may also consist of a text box where a user may enter free text.

The disclosed embodiments include a user interface for the search application which provides certain customizable features which allow a user (or administrator) of the method to more particularly tailor their searching. In one embodiment, the instructions present to the user a tool by which the user may configure one or more words present in the selected search query to be excluded from the search. In another embodiment, the instructions present to the user a tool by which the user may assign one or more substitutions (equivalent words, or groups of words, e.g., “penicillin”, “injectable”, “bed rest”) to a word/element that is present in the search term. In this latter case, the search term includes both the element originally present in the search term and the one or more substitutions.

A further aspect of the disclosure is directed to a method and computer readable medium containing instructions for facilitating searching a database for one or more entries in the database. In this aspect, the particular pre-processing steps are not important but rather the invention facilitates better ranking or ordering of results. The method and instructions implement the steps of: (a) receiving a search term; (b) performing a pre-processing step on the search term, the preprocessing step resulting in a search string for use in searching of the database; (c) conducting a search of the database for entries that match, at least in part, the search string; (d) weighting the search results, and (e) returning the search results; wherein the step of weighting the search results includes at least one of the following weightings: 1) adding a weight score to a search result for every word in the search result which matches a word in the search string (“regular weight”); 2) adding a weight score to a search result if the search contains a code and the search result has a matching code (“code weight”); 3) adding a weight score to a search result if the first word of the search term exists anywhere in the search result (“first word weight”); 4) adding a weight score to a search result if the first word of the search term exists in the search result as the first word (“positional weight”); and 5) adding a weight score to the search result if the search term and the search result are an exact match (“exact match weight”).

The following description will describe examples of searching a medical-related database of terminology, e.g., a database akin to the VantageRx database of Cerner Corporation. The database contains, among other things, a list of medication orders. The search term will be described in the form of a text query seeking a medication order in the database matching the query. The nature or type of the underlying text content in the database is of course not particularly important to the method itself. Applications of the disclosed inventions to other, non-medical, environments are of course possible and the features of this disclosure can be adapted to such other applications by persons skilled in the art. All questions concerning the scope of the invention are to be answered by reference to the appended claims.

### BRIEF DESCRIPTION OF THE DRAWINGS

A presently preferred embodiment of the invention will be described in conjunction with the appended Figures for purposes of illustration and not limitation.

FIG. 1 is a block diagram of a enterprise (e.g., hospital) showing a computer network which includes a database which is searched and a terminal or computer storing instructions performing a search method in accordance with this disclosure. The terminal or computer facilitates a user (not shown) or another software application searching for terms in the database.

FIG. 2 is a flow chart showing the steps of a presently preferred search method, which is coded in software instructions and stored in a memory of a computer in the enterprise of FIG. 1.

FIG. 3 is a flow chart of the pre-processing step of FIG. 2.

FIG. 4 is a flow chart showing the post-processing step of FIG. 2.

FIG. 5 is a screen shot of the main screen of an application implementing one embodiment of the search method of this disclosure.

FIG. 6 is a unit of measure (UOM) table listing units of measurement which may optionally be excluded from a search term.

FIG. 7 is an illustration of a portion of the screen shot of FIG. 5 showing the user accessing a tool which allows a user to configure a substitution list.

FIG. 8 is a screen shot showing the tool allowing a user to configure a substitution list.

FIG. 9 is a screen shot showing the tool allowing a user to add an additional entry to the substitution list of FIG. 8.

FIG. 10 is an illustration of a portion of the screen shot of FIG. 5 showing the user accessing a tool enabling the user to configure an exclusion list.

FIG. 11 is a screen shot showing the tool allowing a user to add or remove an entry in the exclusion list of FIG. 10.

### DETAILED DESCRIPTION

This invention provides a solution to a need in the art for a more efficient method for searching for textual entries in a database. As noted above, prior art database servers such as Microsoft SQL Server include features for full text searching against plain character data in a relational database. However, the full text searching offered by a prior art database server leaves much to be desired, particularly in the medical context. For example, existing full text search tools do not perform well in situations where there is a mismatch between a word in the search term and the database entries, but the content or meaning is the same (such as in the case where the user specifies “ampicillin” in the search term and the word “penicillin” is used instead in the source catalog). They may also not recognize synonyms between groups or clusters of words, such as a medical order of “bed rest” and the same medical order expressed as “stay in bed for 24 hours”. In other words, the search term may specify “apples” and the database may recite “oranges”, but in reality the two mean the same thing but are given entirely different labels. Current full text search tools also need improvement in their ability to rank results in order of importance to the user. In sum, the “one size fits all” approach to full text searching provided by current database searching technology does not work well for many applications, particularly in the medical arena.

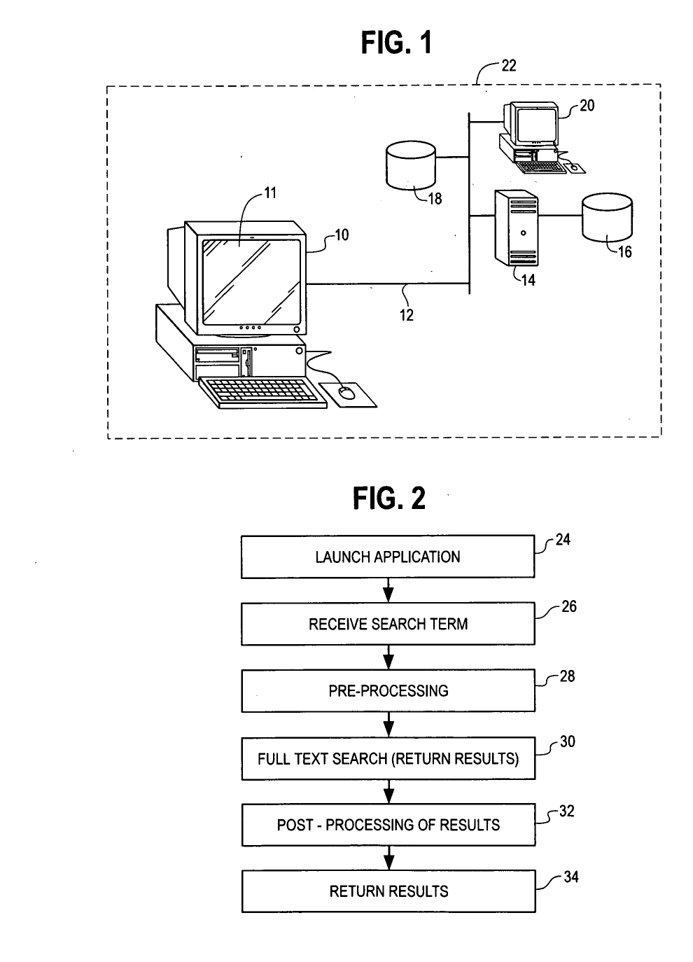

Referring now to FIG. 1, the present disclosure provides a method for facilitating a searching of a database. In one example, a user operates a general purpose computer 10 having a display 11. The computer includes a memory which executes instructions which perform the steps of the search method explained herein. The computer 10 is connected via a network 12 to a database server 14 which provides access to a database 16. The database 16 in this example contains medical related terminology, and may be for example a customer catalog of medical terminology such as medical orders and the like. The database server 14 may also provide access to a second database 18, which may be a standard database such as the VantageRX database described previously. The network 12 is shown implemented in an enterprise 22 which in this example is a hospital or other medical enterprise. Other computers are located on the network, as indicated at 20.

FIG. 2 is a flow chart showing the steps in the process executed by the search method of this disclosure. At step 24, a user operating the computer 10 or 20 launches the search application of this disclosure. Alternatively, the search application may be a feature which is embedded within another larger application and in which case it will be running or available in the background while the main application is executing.

At step 26, the search application receives a search term for searching in the database 16, in this case from the user operating the user interface 11 of the computer 10. The search application could receive the search term from another software process automatically. The phrase “search term” is intended to mean any character-based string, which may contain a single element (e.g., a word, number, abbreviation, code, acronym, etc.), or a group of such elements that are separated from each other by spaces such as a combination of words, numbers and/or abbreviations. Examples of various types of search terms will be explained below. The term “element” is intended to mean any distinct group of characters. Thus, “Tylenol 250 mg” is one example of a search term containing three elements, “Tylenol”, “250”, and “mg”. “Asprin” is another example of a search term. “Ampicillin 250 mg—Inj once” is another example of a search term, containing six elements, i.e., “Ampicillin” “250” “mg” “—” “Inj”, and “once”. “Bed rest” is still another example of a possible search term. Several examples of facilities for receiving a search term from a user will be described below in conjunction with FIG. 5.

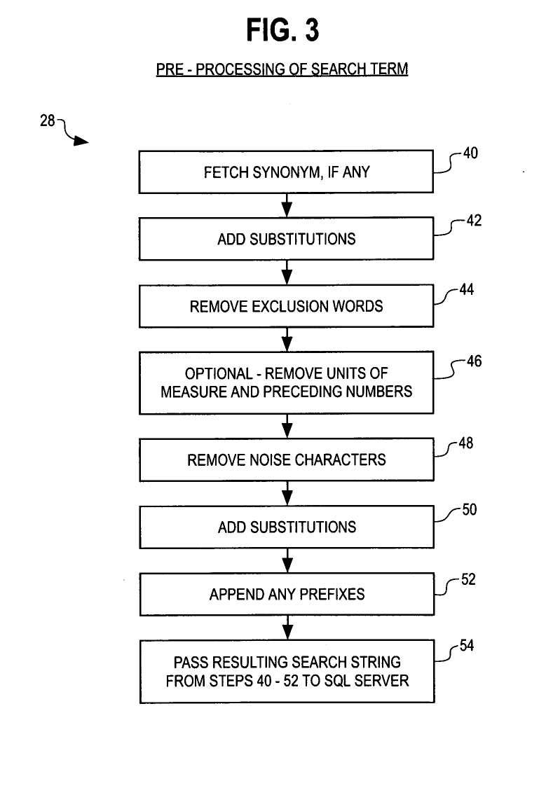

At step 28, after the search term is received, a pre-processing step is performed on the search term. The pre-processing step includes several possible sub-steps, which may be performed in any order or more than once. An example of the pre-processing step 28 is shown in FIG. 3. In preferred embodiments, the pre-processing step including sub-steps of (1) adding one or more substitutions to the search term in the event that an element of the search term has equivalents, (2) comparing elements of the search term with an exclusion list and removing elements from the search term which are present in the exclusion list, and (3) removing noise characters from the search term. The pre-processing step results in a search string for use in searching of the database 16. Depending on the configuration, two or more search strings could be created, such as one based on a synonym to the original search term. In preferred embodiments, a single search string is created and handed off to the database server for full text searching.

At step 30, a full text search is conducted of the database 16. In a typical example, the full text search is conducted by the database server 14. Thus, the search method hands off or passes the search string resulting from the pre-processing step to the database server for a full text search. Also at step 30, the database server returns the search results to the search application. The database server may perform a ranking of the searching and return the search results along with some ranking based on relevance.

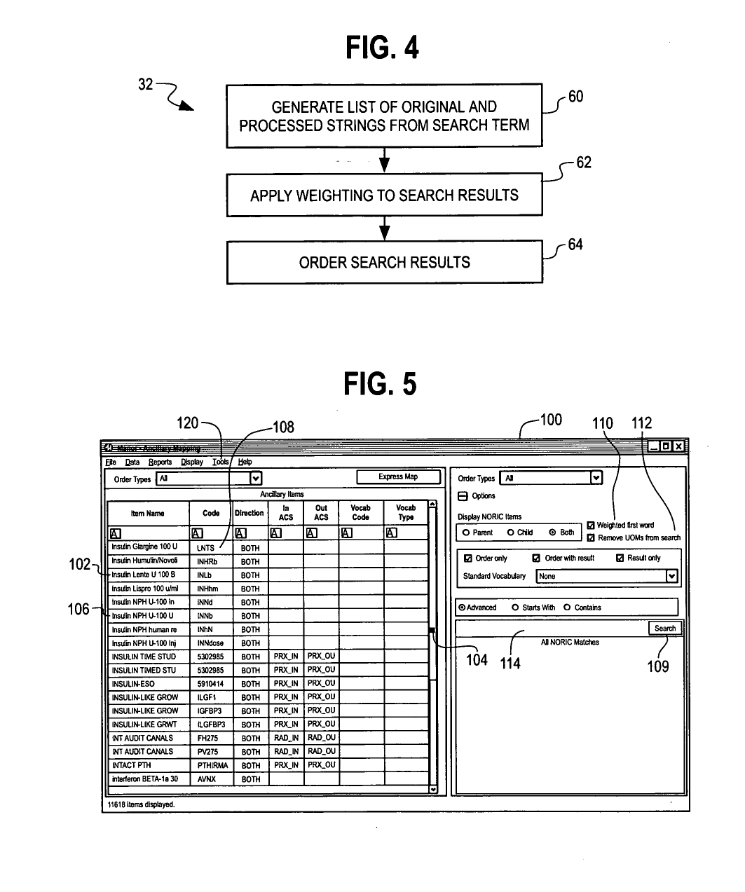

At step 32, post-processing of the search results is done by the search application. This post processing will be described in more detail below in conjunction with FIG. 4.

At step 34, the results are returned to the user or application that invoked the search initially. In a case where a user specified the search term, the results are presented on the display of the terminal 10 along with a ranking or ordering of the results.

FIG. 3 is a more detailed illustration showing one example of the pre-processing step 28 of FIG. 2. In this example, the pre-processing includes sub-steps 40-54. While in a preferred embodiment in the medical context all sub-steps 40-54 are performed, in the order shown, in other embodiments the steps could be done in a different order and/or some sub-steps eliminated.

In sub-step 40, if the entire search term that was entered has a synonym, then that synonym is fetched. Step 40 may make use of a table of synonyms. In the example where the user is provided with a defined list of available search terms (see FIG. 5), the system administrator defines synonyms for some or all of the available search terms and stores them in a table. As an example, “Ampicillin 250 mg—Inj once” is an available search term, and is selected by the user. This term has a synonym: “Penicillin 250 mg/Injectable #4”. This synonym is retrieved from the table of synonyms and added to the search term. Thus, the search term now is augmented to “Ampicillin 250 mg—Inj once Penicillin/Injectable #4”. The elements 250 and mg are duplicate elements in the original search term and the synonym and thus are only represented once in the augmented search term in this example.

At step 42, a substitution step is performed on individual elements of the search term. (This is in contrast to finding a synonym to the entire search term in step 40). In this step, the elements of the search term are compared to a substitution list and one or more substitutions are added to the search term in the event that any of such elements have equivalents as per the substitution list. This will explained below in conjunction with FIG. 8. Consider for example a search term that contains the element “blood”. The element “blood” is compared to a list which contains equivalents to possible search terms. In this case, “blood” has two equivalents—“haem” and heme”. Thus, the words “haem” and “heme” are added to the search term. As another example, the group of elements “complete blood count” has an equivalent of “CBC.” In essence, the substitution step 42 is performed to include synonyms, abbreviations, and otherwise equivalent terms to the elements of the search term. The substitutions can be any string that may or may not contain noise characters. If a group of elements has a substitution defined (e.g., “bed rest”, or “complete blood count”), the search term will be augmented include the substitution(s) to the group of elements. Any element in a search term may have several substitutions in a list. No same string can be used in different substitution lists. For example, “CBC” is in a list of substitutions for “complete blood count”, and is not present as a substitution for any other search element.

At step 44, an exclusion step is performed in which any elements (e.g. word or group of words) in the search term which are present on an exclusion list are deleted from the search term. For example, the exclusion list may specify that the “intracardiac” is to be excluded. If the search term was “intracardiac injection heparin 2 mg”, after execution of step 44 the search term is reduced to “injection heparin 2 mg.” As another example, the exclusion list may specify that the group of words “1 view” are to be excluded. If the search term is “chest Xray 1 view”, after execution of step 44 the search term is reduced to “chest Xray”. The reason for performing the exclusion step is to reduce false positives, i.e., limit the number of matches to the search term which are of little or no interest.

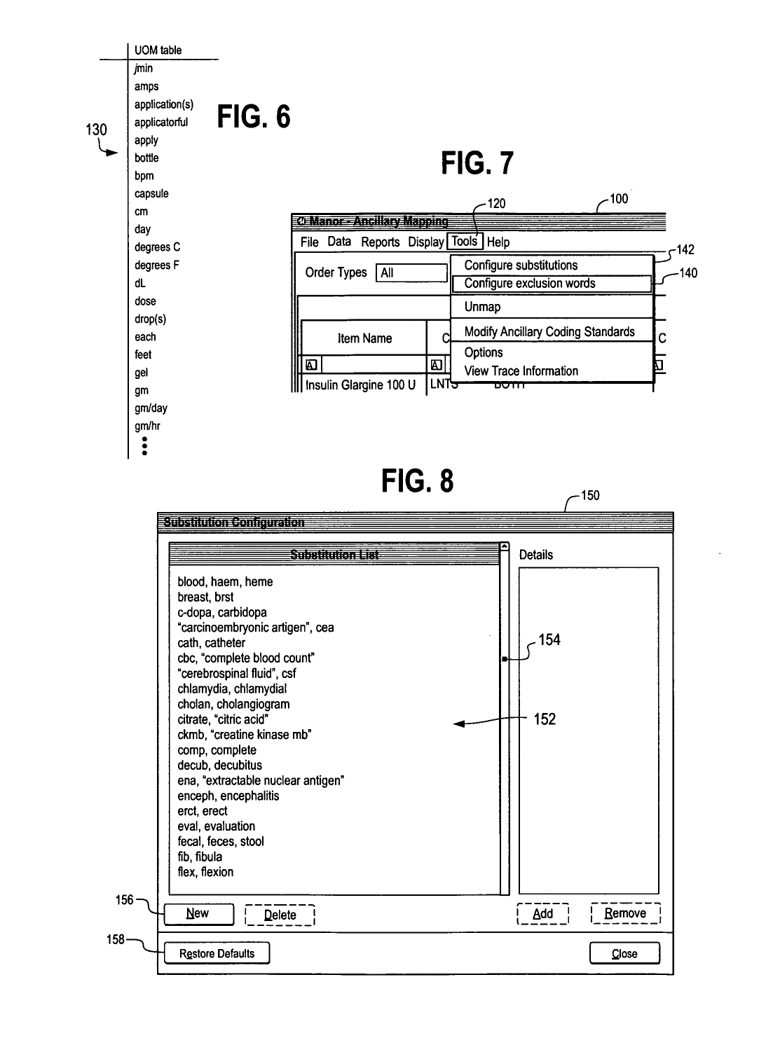

At step 46, an optional step is performed of removing units of measure and numbers which precede a unit of measure. FIG. 6 is an illustration of a table 130 containing units of measure which will be deleted from a search term. A tool is provided for editing the table 130 to add, subtract or change the contents of the unit of measure table. If the user checked the option to exclude units of measure, in the above example where the search term is “intracardiac injection heparin 2 mg”, after step 44 and step 46 the search term is reduced to “injection heparin”.

At step 48, a step is performed of removing noise characters from the search term. It is possible to define noise characters in a manner which is suited to the particular application of the search method. In the present medical example, noise characters are any defined as characters that are not alpha-numeric. Some potential exceptions to this rule may be provided, such as exceptions for commas, periods to properly represent numbers, and apostrophes.

At step 50, the substitution process is performed again (same as step 42). The reason for this is that the removal of exclusion words and noise characters may create new strings of characters (elements in the search term) which may have equivalents, whereas the previous presence of such noise characters may have obscured the fact that such equivalents exist. Thus, the elements from the search term resulting from execution of step 48 are compared to the substitution list and any equivalents present in the substitution list are added to the search term.

At step 52, any prefixes are appended, if applicable. Prefixes are strings of characters that can be included in the search by placing the characters at the beginning of an element of a search term. The prefixes added in this step may be used in the weighting process discussed below.

At step 54 the search string in the form of the original search term after all the preprocessing steps 40-52 have been performed is passed to the database server 14 of FIG. 1 for execution of a full text search (see step 30 in FIG. 2).

FIG. 4 is a flow chart showing the post-processing step 32 of FIG. 2. As indicated at 60, the post-processing step 32 includes a sub-step 60 of generating a list of the original elements (strings) from the search term and the elements (strings) as processed by the pre-processing steps. This sub-step 60 facilitates the ordering of the search results, since some words in the search results will match the original text of the search term while some may match the processed ones. For example, the search may find the term “additional” whereas “add'l” was present in the original search term but the substitution step added the equivalent term “additional”. The pre-processed search term “add'l” will be converted to “add l” (the apostrophe between “add” and “l” will be removed as it was a noise character). Thus, the search may not find a match if the search results contains “add'l” so it is necessary to retain the original element (“add'l”) in the search term in the ordering process. On the other hand if the original search term contains the element “17-hydroxypregnenolone”, the element will be converted to two words “17 hydroxypregnenolone” (the dash is a noise character and removed) and a match to hydroxypregnenolone may be found. The distinction exists because this type of matching does not use sub-string search to eliminate false positives.

At step 62, the process applies a weighting to the search results. There are several different types of weighting that can be performed at step 62.

In one embodiment there are five different weights that are performed: regular weight, code matching weight, first word weight, positional weight, and exact match weighting. In “regular weighting,” a weight score (e.g., a “1” or a “5”) may be added to a search result for every word in the search result which matches a word in the search string. (Note that the search string includes any substitutions and synonyms from the original search term, so the weighting is applicable against the search string). In code matching weight or “code weight,” a weight score is added to a search result if the search contains a code and the search result has a matching code. Here, the term “code” is used to mean a string of characters which is assigned a particular meaning in a given vocabulary, such as a medical shorthand string for a particular order, prescription, test, etc. defined in accordance with industry norms. In “first word weight,” a weight score is added to a search result if the first word of the search term exists anywhere in the search result. In “positional weight,” a weight score is added to a search result if the first word of the search term exists in the search result as the first word. In “exact match weight,” a weight score is added to the search result if the search term and the search result are an exact match. The exact match weight is optionally case insensitive, and optionally only occurs if all the words (elements) in a search string (or original search term) are found exactly in the source database, in the same order. Alternatively, for exact match weighting to apply the order of the elements in a search result need not be the same as in the search term. In one embodiment, if an exact match is found, only that result is returned. In other embodiments, if an exact match is found, it is ranked or ordered first in the search results and the remaining search results are presented below it, ordered by their weighting score, and alphabetically among search results having the same weighting score.

Other rules may also be used for the weighting. For example, if a term in a search result has a synonym and the synonym weight is greater than the term's weight, the term will assume the synonym's weight.

At step 64, the search results are ordered. The order in which the results are presented to the user will normally be based on the sum of the weighting values of the above five types of weighting, where applicable. The weighting value (e.g., a 1, 2, 5, etc.) to assign to search results based on positional weight, first word weight, regular weight, code weight and exact match weight can of course be customized and left as a user-configurable parameter. In one embodiment, the results will be ordered first based on the weighting described in step 62, then ordered based on a ranking provided by data base server based on the full text search, and then ordered alphabetically.

Examples of User Interface Features for Search Method

Several examples of possible user interface features for use in the search method will be described for purposes of example and not limitation.

FIG. 5 is a screen shot of a user interface 100 presented on the display 11 of the computer 10 (FIG. 1) showing two ways of entering a search term. The user interface 100 includes a region 102 where available search terms are displayed. The user manipulates the scroll bar 104 with a mouse to view all the available search terms 106. In this example, the search terms are present in the customer catalog or database 18 of FIG. 1. The search terms are shown in the left hand column under the heading “item name.” Some of the search terms are associated with a code, which is set forth in column 108. Thus, the search term “Insulin Glargine 100 U” has a code associated with it of “LNTS”. If the user wishes to search for this term in the source catalog or database 16, then they highlight the term with their mouse and click on the search icon 109. The search term selected does not include the code, and thus in this example contains the following elements: “Insulin Glargine 100 U”. The code “LNTS” is passed as a separate entity to the search process and used for other purposes not relevant to the present discussion. Thus, one means for entering a search term is selection of a search term from an available list of search terms.

The user interface 100 includes a field 110 where the user can check a box to indicate that first word weighting should be applied. (Other weighting is performed automatically in this example). A field 112 provides the user with the ability to remove units of measure from the search term by checking the box. If the user specifies removal of units of measure, then preceding numerical values in the search term are also removed. Units of measure and preceding numerical values originally presented in the search term are used for the weighting processes described herein.

The user interface 100 also includes a free text box 114 which provides a second means for entering free text and searching on that basis. Thus, there are two alternative means for entering a search term in the user interface of FIG. 5: free text via the box 1 14 and selection of an item 106 from the menu of search terms 102.

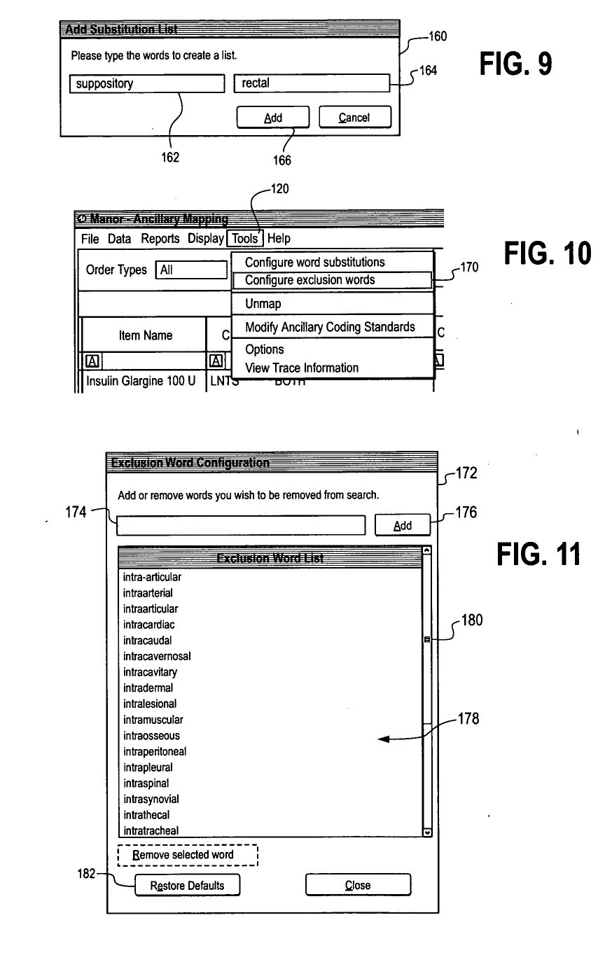

FIG. 7 shows a portion of the user interface 100 showing a tools menu 120 which provides a facility for the user to configure a substitution list. The user has clicked on the tools icon 120 and a pop-up window 140 has appeared. The user highlights and clicks on “configure substitutions 142.” The substitutions configuration tool 150 of FIG. 8 is then presented on the display of the computer. In this display, the substitution list 152 is presented along with a scroll bar 154 for viewing all the entries in the list 152. The substitution list contains equivalent words or terms for elements which may be present in a search term. The substitution list may also contain equivalents for groups of elements (e.g., a collection of words) which are present in the search term. For example, the element “blood” has the equivalent words “haem”, and “heme”. If the user specifies a search term which includes “blood”, “haem” and “heme” are added to the search term, as explained above in conjunction with step 42 of FIG. 3. As another example, the phrase “bed rest” may be an entry in the substitution list, and have the equivalent phrase “stay in bed for 24 hours”. The user is provided with the ability to specify new substitutions. If they click on the icon 156, the display of FIG. 9 is presented. The user types in a word or phrase in the field 162 and an equivalent word or phrase in the field 164 and then clicks on the add icon 166. The substitution list 152 of FIG. 8 is augmented accordingly. If, in FIG. 8, the user clicks on “restore defaults” icon 158, then the default configuration of the substitution list 152 is restored.

FIG. 10 shows a portion of the user interface 100 showing the tools icon 120 and the facility by which a user may configure the exclusion word list (step 44 of FIG. 3). The user has clicked on the tools icon 120 and highlights and clicks on “configure exclusion words” as indicated at 170. The exclusion word configuration tool 172 of FIG. 11 is then presented on the display of the computer. In this display, the exclusion word list 178 is presented along with a scroll bar 180 for viewing all the entries in the list 178. The exclusion list contains words or terms which may be present in the search term but which are to be excluded from the search. In the box 174 the user is allowed to enter text of a new word to be added to the list by clicking on the icon 176. If the user clicks on “restore defaults”, icon 182, then the default configuration of the exclusion word list is restored. The exclusion list may also contain exclusions which are groups of two or more words.

### EXAMPLE 1

The search is initiated for a source catalog term by a user selecting one of the elements 106 in the menu of available search terms 102 in FIG. 5 and clicking on the search icon 109.

A. Pre-Processing

The process searches for synonyms of the selected search term. If a synonym for the search term exits, it is added to the search term (Step 40, FIG. 2).

The process creates a list of elements in the search term, including any synonyms that are found. The substitution step 42 (FIG. 3) is then performed for each of the elements. The elements of the search term are separated from each other by a space or a noise character. The substitution step does not to do a substring search; e.g., the term “10 tablets” will not be replaced by “10 orals” even if there is a substitution between oral and tablet. Next, at step 44, exclusion words (or groups of words) are removed from the search term.

The search optionally removes units of measurement (UOMs) from the search term. This is a user changeable option that enables the removal of UOMs. If enabled, it also removes numbers that precedes the UOM. For example if the term is “niacin 250 mg oral capsule, extended release” both “250” and “mg” will be removed from the search term, leaving “niacin oral capsule, extended release.”

Next, at step 48, the process removes all noise characters from the search term. If the search term is “Hepatitis B core antibody (HBcAb), IgG+IgM” it will become “Hepatitis B core antibody HBcAb IgG IgM.”

The substitution step is performed again (step 50, FIG. 3). If new substitutions are encountered from the processed terms, the search adds those to the search term as well. For example, if the term is “Chest xray AP+BILAT” after noise removal processing it will become “Chest xray AP BILAT.” If there is a substitution for “bilat” of “bilateral”, “bilateral” will also be included in the search term. Thus, the search term becomes “Chest xray AP BILAT BILATERAL.”

If a search term contains a prefix, it will be appended to the search term.

B. Full Text Search

The search string “Chest, xray, AP, BILAT, BILATERAL” is handed over to the SQL Server 14 and the SQL server runs a full text search against the database. The search will be filtered by order type and parameters of order/result item structure of the target catalog and ordered by vocabulary code if one exists.

The process will also search the synonyms of the original search terms (e.g., BILATERAL in additional to BILAT in the above example) in the database. Matches may be found only in synonyms and not the original terms. The results (entries in the database or catalog) are returned to the search application.

C. Post Processing

The search generates a list of processed and original strings (Step 60, described above). Weighting of the search results against the search string is applied as explained above in step 62. The results are ordered at step 64 and presented to the user as indicated at step 34 of FIG. 2.

### EXAMPLE 2

1. The user opens the search application (FIG. 5), is presented with the user interface 100 of FIG. 5 and selects a row 106 from the field 102. Suppose in this example the row recites the following entry from the source catalog: “Ampicillin 250 mg—Inj once”.

2. The search application then gets any synonyms for the entire search term. In this example, “Penicillin 250 mg—Inj #4” is an exact synonym for “Ampicillin 250 mg—Inj once”. The synonym is returned and added to the search term. The resulting search term thus contains the following elements: “Ampicillin 250 mg—Inj once Penicillin #4” (duplicate terms being eliminated).

3. Each element of the search term is compared to the substitution list and any substitutions are added to the search term. “Inj” has the equivalent word “injectable” and so “injectable” is added to the search term.

4. Each element of the search term is compared to an exclusion word list and elements present in the exclusion word list are removed from the search term. “Once” is on the exclusion list and so is removed.

5. Noise characters are removed from the search term resulting from 4.

Thus, the search term becomes “Ampicillin 250 mg Inj Injectable Penicillin 4”.

6. Units of measurement (UOM) are removed. If they are immediately preceded by a number both the number and UOM are removed. This step is optional.

7. The elements of the search term are again checked against the substitution list and any substitutions not already present are added.

As a result of the above pre-processing steps, a search string is created containing the following elements: “Ampicillin”, “Inj”, “injectable” “Penicillin” “4”. If the optional UOM removal step 6 was not performed, then the search string after pre-processing is “Ampicillin”, “250”, “mg”, “Inj”, “injectable” “Penicillin” “4”.

Full Text Search

The search string containing elements “Ampicillin”, “250” “mg”, “Inj”, “injectable” “Penicillin” “4” is handed off to the SQL server (14 in FIG. 1) for full text searching.

The database search returns a list of search results.

Table 1 below is a sample list of search results, in an example where the search string is “Acetaminophen 120 mg Suppository.”

TABLE 1

| | SQL Server |
|---|---|
| Name | Rank |
| No Rectal Temps or Suppositories | 54 |
| Acetaminophen Rectal | 42 |
| Belladonna + Opium Suppository | 32 |
| Aminophylline Rectal | 21 |
| Aspirin Rectal | 21 |
| Bisacodyl Rectal | 21 |
| Caffeine Ergotamine Rectal | 21 |
| Chloral Hydrate Rectal | 21 |
| Diazepam Rectal | 21 |
| Docusate Rectal | 21 |
| Fleets Enema Rectal | 21 |
| Glycerin Rectal | 21 |
| Hydrocortisone Rectal | 21 |
| Indomethacin Rectal | 21 |
| Lactulose Rectal | 21 |
| Rectal Tube, Insert | 21 |
| Acetaminophen | 20 |
| Acetaminophen + Codeine 120 mg-12 mg/5 mL | 20 |
| Acetaminophen + Codeine 300 mg-15 mg | 20 |
| Acetaminophen + Codeine 650 mg-30 mg | 20 |
| Acetaminophen + Hydroc 325 mg-7.5 mg/15 mL | 20 |
| Acetaminophen + Hydroc 500 mg-7.5 mg/15 mL | 20 |
| Acetaminophen + Hydrocodone 250 mg-10 mg | 20 |
| Acetaminophen + Hydrocodone 300 mg-10 mg | 20 |
| Acetaminophen + Oxycodone 325 mg-5 mg | 20 |
| Acetaminophen + Oxycodone 500 mg-5 mg | 20 |
| Acetaminophen + Oxycodone 650 mg-10 mg | 20 |
| Acetaminophen + Propoxyphene 325 mg-100 mg | 20 |
| Acetaminophen + Propoxyphene 325 mg-50 mg | 20 |
| Acetaminophen Level, Gastric | 20 |
| Acetaminophen Level, Serum | 20 |
| Acetaminophen Level, Urine | 20 |

Note:
The list does not contain all the results of the search. Additional search results may be present but are not shown in Table 1.

Post-Processing Steps

The search result list that is returned by the SQL server (14, FIG. 3) has a ranking order that is being provided by SQL Server Full Text Search feature of the SQL server, shown in Table 1. The present search process refines the order of the search result items by performing weighting of the search results.

In regular weighting, for each search result, the software goes through each word and compares it to the elements of the search string (which now includes any synonyms to the original search term or substitutions for elements from the original search term). For every match, the weighting process will add a “1” to the search result item's weight. If “weighted first word” is selected and the first word in the search string is “Ampicillin”, and the result item contains “Penicillin” or “Ampicillin” anywhere, 5 will be added to the result item's weight.

Note: the search string includes any substitution and the substitutions as taken into account in the weighting. For example, if “Ampicillin” has a substitution (i.e. “Amoxicillin”), and “Amoxicillin” is present in a search result, the result will be weighted (e.g., using regular weighting, first word weighting, etc. as applicable).

Code weighting, positional weighting and exact match weighting will also be performed.

Finally, the search results are ordered by weight and then presented to the user. For example, the user's terminal may display the results such as shown in the format of Table 2. Table 2 shows a ranking of the search results based on the different weighting described above given the search string “Acetaminophen 120 mg Suppository.” The numerical value in the two far right hand columns is the sum of the weighting scores for the given search result. The “weighted 1^{st} word rank” column includes the weight score for the “first word weight” whereas the far right column does not include this weight score.

TABLE 2

| | | | Weighted |
|---|---|---|---|
| | | Weighted | without 1^{st} |
| | SQL Server | 1^{st} Word | Word |
| Name | Rank | Rank | Rank |
| Acetaminophen Rectal | 42 | 8 | 4 |
| Acetaminophen | 20 | 7 | 3 |
| Acetaminophen + Codeine 120 mg-12 mg/5 mL | 20 | 7 | 3 |
| Acetaminophen + Codeine 300 mg-15 mg | 20 | 7 | 3 |
| Acetaminophen + Codeine 650 mg-30 mg | 20 | 7 | 3 |
| Acetaminophen + Hydroc 325 mg-7.5 mg/15 mL | 20 | 7 | 3 |
| Acetaminophen + Hydroc 500 mg-7.5 mg/15 mL | 20 | 7 | 3 |
| Acetaminophen + Hydrocodone 250 mg-10 mg | 20 | 7 | 3 |
| Acetaminophen + Hydrocodone 300 mg-10 mg | 20 | 7 | 3 |
| Acetaminophen + Oxycodone 325 mg-5 mg | 20 | 7 | 3 |
| Acetaminophen + Oxycodone 500 mg-5 mg | 20 | 7 | 3 |
| Acetaminophen + Oxycodone 650 mg-10 mg | 20 | 7 | 3 |
| Acetaminophen + Propoxyphene 325 mg-100 mg | 20 | 7 | 3 |
| Acetaminophen + Propoxyphene 325 mg-50 mg | 20 | 7 | 3 |
| Acetaminophen Level, Gastric | 20 | 7 | 3 |
| Acetaminophen Level, Serum | 20 | 7 | 3 |
| Acetaminophen Level, Urine | 20 | 7 | 3 |
| No Rectal Temps or Suppositories | 54 | 1 | 1 |
| Belladonna + Opium Suppository | 32 | 1 | 1 |
| Aminophylline Rectal | 21 | 1 | 1 |
| Aspirin Rectal | 21 | 1 | 1 |
| Bisacodyl Rectal | 21 | 1 | 1 |
| Caffeine Ergotamine Rectal | 21 | 1 | 1 |
| Chloral Hydrate Rectal | 21 | 1 | 1 |
| Diazepam Rectal | 21 | 1 | 1 |
| Docusate Rectal | 21 | 1 | 1 |
| Fleets Enema Rectal | 21 | 1 | 1 |
| Glycerin Rectal | 21 | 1 | 1 |
| Hydrocortisone Rectal | 21 | 1 | 1 |
| Indomethacin Rectal | 21 | 1 | 1 |
| Lactulose Rectal | 21 | 1 | 1 |
| Rectal Tube, Insert | 21 | 1 | 1 |

A further aspect of the disclosure is directed to a method and computer readable medium containing instructions for facilitating searching a database for one or more entries in the database. In this aspect, the particular pre-processing steps are not important but rather the invention facilitates better ranking or ordering of results. Thus, the method and instructions implement the steps of: (a) receiving a search term; (b) performing a pre-processing step on the search term, the pre-processing step resulting in a search string for use in searching of the database; (c) conducting a search of the database for entries that match, at least in part, the search string; (d) weighting the search results, and (e) returning the search results. The step of weighting the search results includes at least one or optionally all five of the following weightings: 1) adding a weight score to a search result for every word in the search result which matches a word in the search string (“regular weight”); 2) adding a weight score to a search result if the search contains a code and the search result has a matching code (“code weight”); 3) adding a weight score to a search result if the first word of the search term exists anywhere in the search result (“first word weight”); 4) adding a weight score to a search result if the first word of the search term exists in the search result as the first word (“positional weight”); and 5) adding a weight score to the search result if the search term and the search result are an exact match (“exact match weight”).

Variations from the disclosed embodiments are of course possible without departure from the scope of the invention.

I claim:

1. A method of searching a database for one or more entries in the database, comprising the steps of:
(a) receiving a search term;
(b) performing a pre-processing step on the search term, the preprocessing step including sub-steps of (1) adding one or more substitutions to the search term in the event that an element of the search term has an equivalent, (2) comparing elements of the search term with an exclusion list and removing elements from the search term which are present in the exclusion list, and (3) removing noise characters from the search term, the pre-processing step resulting in a search string for use in searching of the database;
(c) conducting a search of the database for entries that match, at least in part, the search string;
(d) ordering the search results, and
(e) returning the search results.

2. The method of claim 1, wherein the database comprises a medical-related database.

3. The method of claim 2, wherein the medical-related database contains a list of medication orders and wherein the search seeks a medication order in the database.

4. The method of claim 1, wherein the search term comprises two or more elements and wherein the pre-processing step further comprises the step of adding a synonym for the search term in the event that combination of the two or more elements has a synonym.

5. The method of claim 3, wherein the pre-processing step further comprises the step (4) of removing units of measure from the search term.

6. The method of claim 5, further comprising the step of removing numbers from the search term which precede a unit of measure.

7. The method of claim 1, wherein the ordering step comprises a step of weighting the search results, wherein the weighting the search results includes at least one of the following weightings:
1) adding a weight score to a search result for every word in the search result which matches a word in the search string (“regular weight”);
2) adding a weight score to a search result if the search contains a code and the search result has a matching code (“code weight”);
3) adding a weight score to a search result if the first word of the search term exists anywhere in the search result (“first word weight”);
4) adding a weight score to a search result if the first word of the search term exists in the search result as the first word (“positional weight”); and
5) adding a weight score to the search result if the search term and the search result are an exact match (“exact match weight”).

8. The method of claim 7, wherein the ordering step performs weightings (1) through (5).

9. The method of claim 1, wherein in the event that the search returns a result in the database which is an exact match for the search term then only that result is returned.

10. The method of claim 1, wherein the search term is obtained from a user by providing a menu of available search terms, and wherein the method includes the step of providing a facility by which a user may select one of the available search terms.

11. The method of claim 10, further comprising the step of providing to the user a tool by which the user may configure one or more elements present in the selected search term to be excluded from the search.

12. The method of claim 10, further comprising the step of providing to the user a tool by which the user may assign one or more substitutions to an element present in the selected search term, wherein the search term is augmented to include both the element present in the search term and the one or more substitutions.

13. A method of searching a database for one or more entries in the database, comprising the steps of:
(a) receiving a search term;
(b) performing a pre-processing step on the search term, the pre-processing step resulting in a search string for use in searching of the database;
(c) conducting a search of the database for entries that match, at least in part, the search string;
(d) weighting the search results, and
(e) returning the search results;
wherein the step of weighting the search results includes at least one of the following weightings:
1) adding a weight score to a search result for every word in the search result which matches a word in the search string (“regular weight”);
2) adding a weight score to a search result if the search contains a code and the search result has a matching code (“code weight”);
3) adding a weight score to a search result if the first word of the search term exists anywhere in the search result (“first word weight”);
4) adding a weight score to a search result if the first word of the search term exists in the search result as the first word (“positional weight”); and
5) adding a weight score to the search result if the search term and the search result are an exact match (“exact match weight”).

14. A computer-readable medium containing a set of instructions for execution by a computer, wherein the set of instruction facilitate the searching of a database for one or more entries in the database, wherein the instructions comprise the instructions for:
(a) providing a facility for receiving a search term;
(b) performing a pre-processing step on the search term, the preprocessing step including sub-steps of (1) adding one or more substitutions to the search term in the event that an element of the search term has an equivalent, (2) comparing elements of the search term with an exclusion list and removing elements from the search term which are present in the exclusion list, and (3) removing noise characters from the search term, the pre-processing step resulting in a search string for use in searching of the database;
(c) forwarding the search string to a database server;
(d) receiving a list of search results from the database server;
(e) ordering the search results, and
(f) returning the search results.

15. The computer readable medium of claim 14, wherein the facility for receiving a search term comprises a menu of available search terms, the available search terms comprising a catalog of terms present in a second database separate from the database, and a means by which a user may select one of the available search terms for searching.

16. The computer readable medium of claim 15, wherein the instructions further comprise instructions for presenting to the user a tool by which the user may configure one or more elements present in the selected search term to be excluded from the search.

17. The computer readable medium of claim 14, wherein the database comprises a medical-related database.

18. The computer readable medium of claim 17, wherein the medical-related database contains a list of medication orders and wherein the search term seeks a medication order in the database.

19. The computer readable medium of claim 14, wherein the instructions for ordering the search results comprise instructions for weighting the search results, wherein the weighting the search results includes at least one of the following weightings:
1) adding a weight score to a search result for every word in the search result which matches a word in the search string (“regular weight”);
2) adding a weight score to a search result if the search contains a code and the search result has a matching code (“code weight”);
3) adding a weight score to a search result if the first word of the search term exists anywhere in the search result (“first word weight”);
4) adding a weight score to a search result if the first word of the search term exists in the search result as the first word (“positional weight”); and
5) adding a weight score to the search result if the search term and the search result are an exact match (“exact match weight”).

20. The computer readable medium of claim 19, wherein the instructions for ordering the search results performs weightings (1) through (5).

21. The computer readable medium of claim 14, wherein in the event that the search returns a result in the database is an exact match for the search term then the instructions (f) return only that result.

22. A computer-readable medium containing a set of instructions for execution by a computer, wherein the set of instruction facilitate the searching of a database for one or more entries in the database, wherein the instructions comprise the instructions for:
(a) providing a facility for receiving a search term;
(b) performing a pre-processing step on the search term, the preprocessing step resulting in a search string for use in searching of the database;
(c) forwarding the search string to a database server;
(d) receiving a list of search results from the database server;
(e) weighting the search results, and
(f) returning the search results,
wherein the instructions for weighting the search results perform at least one of the following weightings:
1) adding a weight score to a search result for every word in the search result which matches a word in the search string (“regular weight”);
2) adding a weight score to a search result if the search contains a code and the search result has a matching code (“code weight”);
3) adding a weight score to a search result if the first word of the search term exists anywhere in the search result (“first word weight”);
4) adding a weight score to a search result if the first word of the search term exists in the search result as the first word (“positional weight”); and
5) adding a weight score to the search result if the search term and the search result are an exact match (“exact match weight”).

23. The computer readable medium of claim 22, wherein the instructions for weighting the search results performs weightings (1) through (5).

24. The computer readable medium of claim 22, wherein the database comprises a medical-related database containing a list of medication orders and wherein the search term seeks a medication order in the database.
